(19) United States
(12) Patent Application Publication
(10) Pub. No.: US 2008/0216385 A1
(43) Pub. Date: Sep. 11, 2008

(54) Microencapsulated animal trap bait for escape-proof repeating animal traps

(76) Inventor: John Peters, Hobe Sound, FL (US)

Correspondence Address: MCHALE & SLAVIN, P.A., 2855 PGA BLVD, PALM BEACH GARDENS, FL, 33410, US

(21) Appl. No.: 11/725,061

(22) Filed: Mar. 15, 2007

Related U.S. Application Data
(63) Continuation-in-part of application No. 11/684,248, filed on Mar. 9, 2007.

(51) Int. Cl. A01M 23/08; A01M 23/00

(52) U.S. Cl. 43/66; 43/58; 43/65

(57) ABSTRACT

The present invention is directed to a microencapsulated bait for application to repeating animal traps for luring animals to the trap. The microencapsulated bait can be applied during manufacturing of new traps or to existing traps alike. The microencapsulated bait may be applied to the trap via brush, spray or adhesive backed tape. The microencapsulated bait can be activated by merely scratching the portion of the trap containing the microcapsules. Alternatively the microcapsules may be constructed and arranged for timed release of the scents, flavors or phermones contained therein.

### RELATED APPLICATIONS

This application is related to U.S. application Ser. No. 10/866,403 now U.S. Pat. No. 7,117,631 entitled MICROENCAPSULATED ANIMAL TRAP BAIT AND METHOD OF LURING ANIMALS TO TRAPS WITH MICROENCAPSULATED BAIT, the contents of which are incorporated herein by reference. In addition, this application is a continuation in part of U.S. application Ser. No. 11/684,248 entitled MICROENCAPSULATED ANIMAL TRAP BAIT FOR ELECTRONIC TRAPS, the contents of which are incorporated herein in their entirety.

### FIELD OF THE INVENTION

This invention is directed to a reusable or disposable animal trap bait that utilizes microencapsulation technology to provide controlled release of scents and/or flavors and may be utilized with a pre-existing animal trap such that the trap does not require perishable bait. Further, the microencapsulated bait may be easily applied to animal traps by the manufacturer or may be purchased as a kit and applied to the trap after purchase by the consumer.

### BACKGROUND OF THE INVENTION

Throughout the centuries, rodents such as rats and mice have thrived among human civilizations. Rodents have been responsible for damage to property and the spread of infectious disease to humans and animals alike. In response, traps have been used by land owners and the pest extermination industry to exterminate rodents. Animal traps have been around for hundreds of years and include many different designs. Most common is the typical rodent snap trap that utilizes a spring and a snapping bar to kill the target animal.

For example, U.S. Pat. No. 7,117,631 to the instant inventor discloses a snap-type trap in combination with a microencapsulated bait. While snap-traps are effective for catching targeted animals, they can be unpleasant to handle and pose a danger to the consumer setting the trap.

Glue traps are paper or cardboard covered in a non-drying strong adhesive to entrap mice or rats, see U.S. Pat. No. 5,477,636 to Musket and U.S. Pat. No. 5,384,981 to Cohen. These traps are economical and easy to set, however they typically utilize grain such as wheat for bait. Grains may sour under damp conditions causing odors that are unacceptable for indoor use. Kloczko, U.S. Pat. No. 6,505,434, discloses a glue trap for catching insects which utilizes microparticles having a high absorption rate and saturated with pheromones to lure insects to the glue. The saturated microparticles are mixed with glue and spread over the surface of the glue board.

Numerous chemical control means have been employed to encapsulate chemical rodenticides to mask odors and/or taste. However, these poisons have several major drawbacks. Once chemically poisoned, a rodent may die and decompose in an inaccessible place, such as inside a wall, creating a possible odor problem or additional infestation. Moreover, a few species and strains of rodents will detect and avoid the chemical odor and others are resistant all together. Sometimes, household pets become the victims of these chemical control means. In addition, extensive precautions must be taken by the exterminator to prevent poisoning of himself during distribution of the chemicals.

U.S. Pat. No. 4,490,352 to Miller is directed towards an encapsulated rodenticide. The patent teaches the inclusion of bait within an encapsulated thermoplastic polyamide. The bait is a zinc phosphate used as a toxicant; the encapsulation masks the odor and taste.

Similarly, WIPO Publication: WO 90/00005 to Redding is directed towards a microencapsulated poison containing a pesticide core material surrounded by lure outer coating. The lure coating comprises a food, sugar or pheromone.

United States Pre-Grant Publication 2004/0031189 to Brown is directed toward a poison bait module, an olfactory attractor portion disposed adjacent the poison portion and a visual attractor portion, wherein the olfactory attractor portion comprises food. The visual attractor portion comprises a reflective material.

Poisons of any kind require very serious safety considerations for storage and distribution. Gloves must be worn when handling poisons and respirators must be utilized to avoid inadvertent inhalation. Coated and/or microencapsulated poisons require additional considerations. The poisons of the prior art are generally coated with a bright and attractively scented material to mask the poison contained therein. Brightly colored and/or attractively scented granules may be mistaken for food by children and/or family pets and ingested.

The article “‘Death by chocolate’ trap for mice”, Newscientist.com, discloses a chocolate-scented mousetrap to catch pests without the need for bait. The article discloses the construction of the traditional mousetrap using ABS plastic granules mixed with chocolate essence. However, the chocolate fragrance fades after six months and cannot be reactivated.

Due to the problems associated with mechanical and chemical trapping methods, many other types of animal traps, particularly rodent traps, have been utilized. One alternative to poisons and snap traps is to use escape-proof repeating animal traps to catch the target animal. Traps of this nature are typically easier to set, no spring loaded bail, and do not produce an unsightly result when the consumer catches a rodent or the like.

Escape-proof repeating animal traps generally include a plastic encasement. An opening is provided into the encasement for entry of a target animal. Through the opening is a pivoting floor member which moves as the animal crosses to prevent the animal from exiting the trap. An enlarged chamber is provided so that multiple animals may enter the trap without the possibility of exit. Examples of escape-proof repeating animal traps are shown in U.S. Pat. Nos. 4,144,667, 6,622,422, 6,694,669, 6,955,007 and 6,990,766 the contents of which are incorporated herein by reference. These traps are most commonly baited with a perishable bait to attract the rodents. These baits are often temperature sensitive and can decompose over time. Moreover, the bait used must be far enough into the trap to ensure the rodent will enter the trap, to prevent the rodent from feeding on the bait without being trapped. Further, the perishable bait can be difficult and time consuming to attach to the trap. These traps often require the user to remove a portion of the trap to access the baiting area of the trap. Because a portion of the bait is typically unused, the user is faced with removing unused or rancid bait which may be difficult and unpleasant for the user.

While the foregoing described prior art devices have improved the art and in some instances enjoyed commercial success, there remains nonetheless a continuing need in the art for evermore improved animal trap and bait combinations.

Accordingly, what is lacking in the art is a safe, effective and non-toxic animal trap bait that can be easily applied to new as well as pre-existing animal traps. The animal trap bait should be non-perishable, reusable and disposable by conventional means.

### SUMMARY OF THE INVENTION

The present invention described herein is a microencapsulated bait for new as well as pre-existing escape-proof repeating animal traps that may be either applied during the manufacturing stage or after purchase by the consumer to attract target animals to the trap.

Rodents such as mice, rats and the like do not have good eyesight and therefore generally rely on their elevated olfactory senses to find food. Most rodents will eat anything when food is scarce. Mice are particularly attracted to sweet smells, e.g. chocolate and fruit, while rats are more attracted to protein-based foods such as peanut butter, peanut oil, bacon and other meats. Rodents are also attracted to pheromones. Pheromones are biochemicals secreted by the animal to communicate to others of the same species. They act as signposts, guiding rodents to food, throughways and safe territories.

Microencapsulation or “scratch-and-sniff” technology was first developed for use in NCR (no carbon required) paper and has been used effectively in other areas, for example, to provide perfume samples in advertisements. The microencapulation process generally involves mixing the material to be encapsulated, such as scent or pheromone, with a polymer and then, through a number of controlled steps fragile microcapsules that contain the material are produced. The microcapsule wall protects the encapsulated material from the effects of oxidation and UV light, extending the effective life of the material. The microcapsules can be imbedded or layered onto the surface of a substrate for storage and/or use. When the user scratches, or otherwise disturbs, the coated substrate surface some of the microcapsules are fractured and the material contained within is emitted.

In addition, the encapsulated material may be released from within the microcapsules by diffusion through pores in the microcapsule wall. This creates a controlled time-release product. The length of time over which the encapsulated material is released may be altered to suit a particular need.

Accordingly, it is an objective of the instant invention to provide a microencapsulated scent, flavor and/or pheromone type bait that can be easily applied to new as well as pre-existing escape-proof repeating animal traps for luring target animals thereto.

It is another objective of the instant invention is to teach a microencapsulated bait for escape-proof repeating animal traps that can be sprayed, brushed or supplied on an adhesive backed substrate and placed in a predetermined position of the trap for attracting target animals thereto.

Still another objective of the instant invention to teach an adhesive backed lure for escape-proof repeating animal traps that includes rows, columns, grids or arrays of microencapsulated bait areas that may be selectively activated.

Yet another objective of the instant invention is to teach a lure for escape-proof repeating animal traps that includes rows, columns, grids or arrays of microencapsulated baits each of which may be selectively activated and each of which may be directed to a different target animal.

Still yet another objective of the instant invention is to teach microencapsulated baits for use in escape-proof repeating animal traps that are targeted to specific animals, i.e. sweet smells for mice, protein-based smells for rats.

A further objective of the instant invention is to teach a microencapsulated escape-proof repeating animal trap bait kit which saves time, since pest control technicians and other end users can use these traps without applying traditional perishable bait thereto.

Yet a further objective of the instant invention is to teach microencapsulated escape-proof repeating animal trap baits that can be utilized both indoors and outdoors without decomposing or influence by environmental conditions.

Still yet a further objective of the instant invention is to teach microencapsulated baits for escape-proof repeating animal traps that will be effective against various forms of target animals, including, but not limited to various rodents, gophers, squirrels and birds.

An even further object of the instant invention is to teach microencapsulated animal bait that will be effective in luring target animals when used in combination with pre-existing escape-proof repeating animal traps.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a perspective view of an escape-proof repeating animal trap;

FIG. 2 is a top view of the escape-proof repeating animal trap of FIG. 1 with the lid portion removed, illustrating one embodiment of the instant invention having a flexible substrate with a single microencapsulated bait area;

FIG. 3 is a perspective view of one embodiment of the instant invention, illustrating an adhesive backed flexible substrate having multiple microencapsulated bait areas;

FIG. 4 is a perspective view of the escape-proof repeating animal trap of FIG. 1 with the lid portion removed, illustrating a liquid microencapsulated bait being positioned on a surface of the trap with a brush.

FIG. 5 is a perspective view taken along lines 2-2 of FIG. 1, illustrating one embodiment of the instant invention wherein the microencapsulated bait is sprayed onto a surface of the trap.

### DETAILED DESCRIPTION OF THE INVENTION

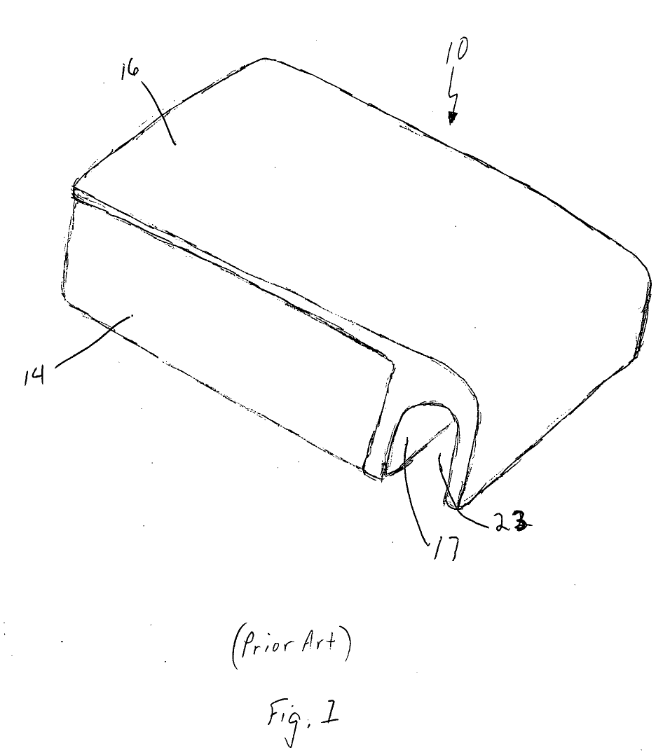

The instant invention has developed an innovative way in which to use microencapsulation technology to lure animals, preferably rodents, into a trap. FIG. 1 is illustrative of a known prior art escape-proof repeating animal trap 10 for which the instant invention may be utilized. Such traps are currently distributed by Woodstream of Lititz, Pa., and are sold under the trademark VICTOR. As used herein the terms repeating animal trap is used to refer to animal traps which utilize movable door members and or platforms to capture a targeted animal within a container. One of ordinary skill in the art will recognize that the instant invention could be used with various repeating traps known in the art which include, but should not be limited to, those disclosed in U.S. Pat. Nos. 4,144,667, 6,622,422, 6,694,669, 6,955,007 and 6,990766 the contents of which are incorporated herein by reference. One of ordinary skill in the art will also recognize the size of the trap can be adjusted to a size appropriate for the animal for which the trap is directed.

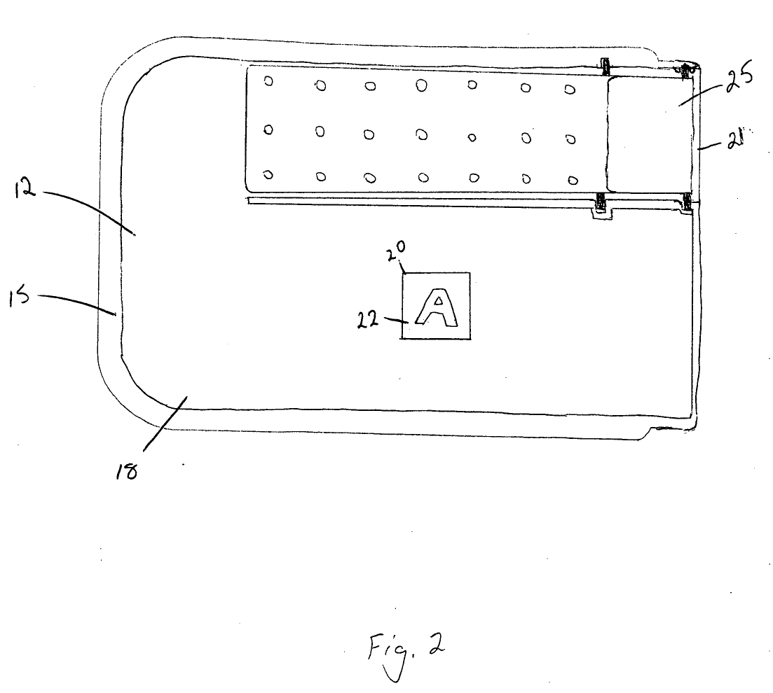

Referring to FIGS. 1 and 2, the preferred embodiment of the repeating animal trap 10 includes a bottom wall 12, a pair of upstanding side walls 14, an upstanding rear wall 15, an upstanding front wall 17, and a cover 16. The bottom wall, side walls, front wall, rear wall and cover are generally constructed from, but should not be limited to, plastic, wire mesh, sheet metal, wood and suitable combinations thereof. The bottom wall 12, side walls 14, rear wall 15, front wall 17, and cover 16 are connected together to define an enclosure having an interior chamber 18 for containment of multiple target animals. Ingress to the interior chamber is provided via an opening 21. Corridors or passageways 23 may be included to route the target animal to the opening or between the opening and interior chamber. A moveable barrier or door member 25 is provided to prevent the target animals from escaping the chamber after entry by blocking the opening. Springs (not shown), levers 27, actuators (not shown) and the like may be utilized for operation of the door member.

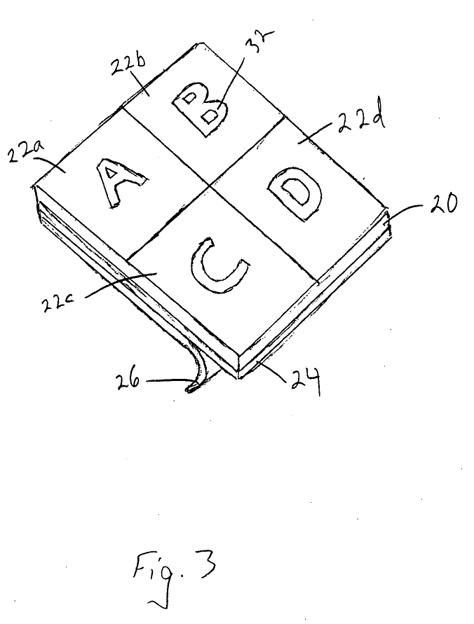

Referring to FIG. 2, a flexible bait substrate having a single microencapsulated bait area is illustrated in a position on the bottom wall 12. The bait substrate 20 includes a single scent release area 22 of microencapsulated bait thereon. The substrate 20 is preferably manufactured from materials well known in the art used for adhering microencapsulated scents thereto. The substrate preferably includes an adhesive layer 24 (FIG. 3) for adhering the microencapsulated bait to wood, metal, plastic or other substrates from which traps can be manufactured. The substrate may be supplied with a backing layer 26 which can be removed prior to attaching the substrate to a surface of the trap. Skilled persons will appreciate that the sizes of the substrate 20 and scent release area 22 can be adjusted to conform to the size of the bottom wall or other surface of the trap and can be adapted to the size of the animals to which the scent release areas 22 are directed. Moreover, the scent release area 22 may cover all or part of the substrate 20. Although the substrate 20 and scent release area 22 are both shown as rectangular, skilled persons would realize that the scent area 22 or substrate 20 could be any variety of shapes, sheets or rolls (not shown).

Moreover, one of ordinary skill will appreciate that the scent release areas 22 can be directly incorporated into the materials used to construct some or all of the trap components, e.g. bottom, side walls, etc. Additionally, the substrate 20 can be applied with a natural or synthetic solution, compound or mixture that includes microcapsules having smells or tastes of the desired bait, for example peanut butter or chocolate, thereby creating a delocalized scent release area. Such microencapsulated scenting/flavoring agents are known in the art and are commercially available from a variety of sources, including the Ronald T. Dodge Company of Dayton, Ohio and Minnesota Mining and Manufacturing Company (3M) of St. Paul, Minn.

The Microencapsulated bait can be produced by a variety of methods known in the art; for example, macroemulsion processes, entrapment/matrix encapsulations, etc. The amount and density of scent/flavor producing agents, e.g. microcapsules, produced by the microencapsulation process can be adjusted to provide the desirable fragrance release characteristics based on pressure, friction or other factors. Additionally, the porosity of the microcapsule walls can be adjusted such that the encapsulated bait is released over an extended period of time. Since the animals that are the desired targets of the present invention are generally scavengers, they have a highly developed sense of smell. Consequently, the scent intensity of the present invention can be manufactured well below what would be noticeable to humans.

Referring to FIG. 3, an alternate embodiment of the instant invention having an array of preformed multiple microencapsulated bait areas 22a, 22b, 22c, and 22d on a substrate 20 is shown. The scent release areas 22a, 22b, 22c, and 22d can be scented and/or flavored with the microencapsulated bait of the present invention. The scent release areas 22a, 22b, 22c, and 22d can have different fragrances and/or flavors, e.g. chocolate and peanut butter, such that the consumer can activate the desired scent targeted for the specific target animal. For example, if the consumer has a rat problem, the product of the instant invention can come in a kit that includes a repeating animal trap and the substrate 20 having an array of multiple scent areas 22a, 22b, 22c, and 22d so that the consumer can simply scratch one or more of the scent areas to activate the scent, flavor or pheromone contained therein. The substrate 20 could also include indicia 32 that specifies to the end user what animal the scent areas are directed to attract. The indicia could be letters or symbols well known in the art. Alternatively, all of the scent release areas 22a, 22b, 22c, and 22d in FIG. 3 could have the same fragrances and/or flavors such that the consumer can activate a different scent area, i.e. 22b, after the scent of the first, 22a, has faded. This is an especially useful feature for pest control tradesmen who reuse the same traps repeatedly.

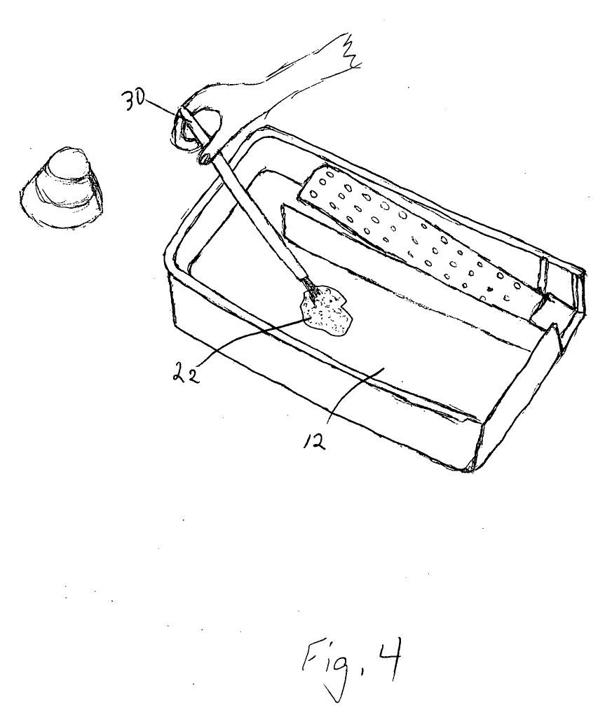

Referring to FIG. 4, a partial view of a conventional repeating animal trap 10 is illustrated with the microencapsulated bait of the instant invention positioned on the bottom wall 12 of the trap. In this embodiment the microencapsulated bait is supplied as a liquid 28 which can be brushed onto a surface of the trap. In a most preferred embodiment the microencapsulated bait is suspended in a suitable carrier which may remain in a liquid state or alternatively may dry to the touch leaving the microcapsules in place. One skilled in the art would recognize that the microcapsules could be ruptured to emit scent either during or subsequent to application with the brush 30.

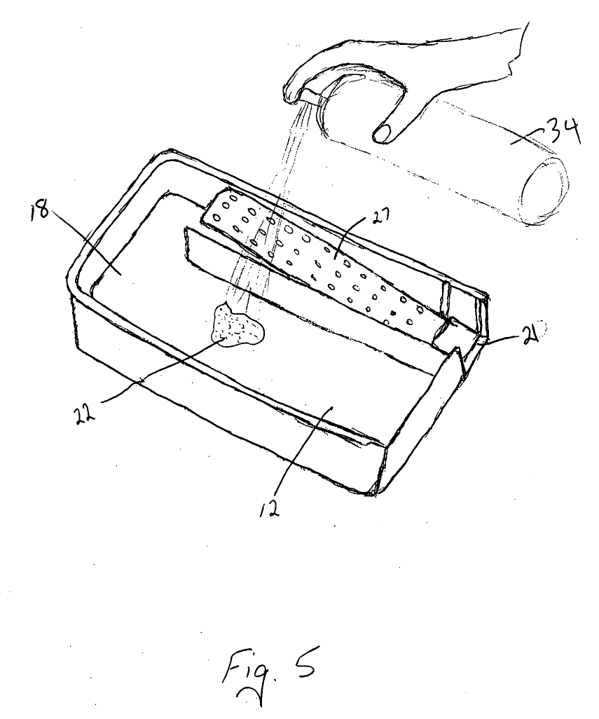

FIG. 5 demonstrates another embodiment of the instant invention wherein the microencapsulated scent can be sprayed onto a surface of a conventional repeating animal trap 10. In the preferred embodiment the microencapsulated bait is applied via a pressurized aerosol container 34. The use of a spray allows the user to apply, or reapply, the microencapsulate bait without touching the trap. The less the trap is handled by the end-user, the less likely the targeted animal will shy away from any human odor that might be left on the trap.

Microencapsulated scents and/or flavors utilized in the instant invention are constructed and arranged to last up to twenty years and could be added to multiple traps and stored for extended lengths of time. In this manner, the present invention may be utilized to improve efficiency and increase safety of new as well as pre-existing electric traps.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. Any compounds, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. In combination, a repeating animal trap including a housing having a bottom wall, upstanding peripheral walls, and a cover, the bottom wall, peripheral walls and cover together defining an enclosure for holding at least one targeted animal, at least one of said walls including an entrance opening for providing target animal access to an interior portion of said enclosure, and at least one barrier member being moveable between an open position and a closed position, wherein said open position allows said target animal to enter said interior portion of said enclosure and wherein said closed position prevents said target animal from exiting said interior portion, and an animal lure having at least one microencapsulated bait for luring said target animal into said chamber, said microencapsulated bait being constructed and arranged for user controlled release with respect to the amount of said microencapsulated bait released.

2. The animal trap of claim 1, wherein said at least one microencapsulated bait is at least one member selected from the group consisting of: microencapsulated food scent, microencapsulated food flavor, or microencapsulated pheromone.

3. The animal trap of claim 1, wherein said lure includes a flexible substrate, said flexible substrate having a first surface and a second surface, said first surface including said at least one microencapsulated scent portion thereon, wherein said flexible substrate may be removably secured to said interior chamber.

4. The animal trap of claim 3, wherein said second surface includes an adhesive.

5. The animal trap of claim 3, wherein said first surface of said substrate includes multiple microencapsulated bait portions thereon, wherein each of said microencapsulated bait portions may be individually activated to lure animals to said trap.

6. The animal trap of claim 5, wherein said microencapsulated bait portions are activated by scratching said first surface.

7. The animal trap of claim 5, wherein each of said multiple microencapsulated bait portions include substantially similar microencapsulated bait therein.

8. The animal trap of claim 5, wherein said multiple microencapsulated bait portions include a variety of different microecapsulated baits, wherein said microencapsulated baits may be individually or simultaneously activated.

9. The animal trap of claim 5, wherein said multiple microencapsulated bait portions are arranged into rows, columns or arrays, wherein said rows, columns or arrays each include indicia imprinted thereon, wherein said indicia is indicative of said microecapsulated bait.

10. The animal trap of claim 1, wherein said microencapsulated bait is a liquid.

11. The animal trap of claim 10, wherein said liquid is applied to a surface of said chamber with a brush, whereby said liquid deposits a layer of said microecapsulated bait on a surface of said chamber.

12. The animal trap of claim 10, wherein said microencapsulated bait is applied to a surface of said chamber as a spray, whereby said spray deposits a layer of said microecapsulated bait on a surface of said chamber.

13. In combination, a repeating animal trap including a housing having a bottom wall, upstanding peripheral walls, and a cover, the bottom wall, peripheral walls and cover together defining an interior chamber for holding at least one target animal, at least one of said walls including an entrance opening constructed and arranged to allow ingress of said at least one target animal into said interior chamber and a door member constructed and arranged to prevent egress of said at least one target animal from said interior chamber upon entrance thereto, and an animal lure positioned within said interior chamber having at least one microencapsulated bait for luring said target animal into said chamber.

14. The animal trap of claim 13, wherein said at least one microencapsulated bait is at least one member selected from the group consisting of: microencapsulated food scent, microencapsulated food flavor, or microencapsulated pheromone.

15. The animal trap of claim 13, wherein said lure includes a flexible substrate, said flexible substrate having a first surface and a second surface, said first surface including said at least one microencapsulated scent portion thereon, wherein said flexible substrate may be removably secured to said interior chamber.

16. The animal trap of claim 15, wherein said second surface includes an adhesive.

17. The animal trap of claim 15, wherein said first surface of said substrate includes multiple microencapsulated bait portions thereon, wherein each of said microencapsulated bait portions may be individually activated to lure animals to said trap.

18. The animal trap of claim 17, wherein said microencapsulated bait portions are activated by scratching said first surface.

19. The animal trap of claim 17, wherein each of said multiple microencapsulated bait portions include substantially similar microencapsulated bait therein.

20. The animal trap of claim 17, wherein said multiple microencapsulated bait portions include a variety of different microecapsulated baits, wherein said microencapsulated baits may be individually or simultaneously activated.

21. The animal trap of claim 17, wherein said multiple microencapsulated bait portions are arranged into rows, columns or arrays, wherein said rows, columns or arrays each include indicia imprinted thereon, wherein said indicia is indicative of said microecapsulated bait.

22. The animal trap of claim 13, wherein said at least one microencapsulated bait is a liquid.

23. The animal trap of claim 22, wherein said liquid is applied to a surface of said chamber with a brush, whereby said liquid deposits a layer of said microecapsulated bait on a surface of said chamber.

24. The animal trap of claim 22, wherein said at least one microencapsulated bait is applied to a surface of said chamber as a spray, whereby said spray deposits a layer of said microecapsulated bait on a surface of said chamber.
